(19) United States
(12) Patent Application Publication
(10) Pub. No.: US 2014/0224090 A1
(43) Pub. Date: Aug. 14, 2014

(54) Macroperforator Machine for Plastic Film

(71) Applicant: Francisco Ruiz Bernal, Cieza (ES)

(72) Inventor: Francisco Ruiz Bernal, Cieza (ES)

(21) Appl. No.: 14/342,559

(22) PCT Filed: Sep. 5, 2011
(86) PCT No.: PCT/ES2011/070624

§ 371 Date: Mar. 4, 2014

(51) Int. Cl. B26F 1/42; B26D 7/18

(52) U.S. Cl. CPC B26F 1/42; B26D 7/1854
USPC 83/566; 83/168

(57) ABSTRACT

Machine for producing macroperforated plastic film by means of a cold-stamping process, using entrainment (3) and stamping (4) rollers, with adjustment of pressure; said machine is provided with an automated system for recovering the excess material cut out for the recycling (8) thereof and the purpose of the machine is to produce a (single-layer or multi-layer) sheet of macroperforated film for use, essentially, in the packaging of palletized systems, thereby allowing optimum ventilation without creating a thermal barrier, resulting in a reduction in consumption of polymeric materials with no reduction in mechanical strength.

### FIELD OF THE ART

The invention intended to be patented relates to the field of the manufacture of industrial machinery intended for the treatment, transformation and adaptation of laminated plastic material.

### STATE OF ART

The aim of providing micro or macroperforated plastics is having a resistant material, primarily intended for the packaging in palletizing systems, that permits an optimal ventilation without creating a thermal barrier, thereby reducing consumption of polymeric materials without diminishing mechanical resistance.

At present, within the field of plastic film treatment, there exist several stamping techniques aimed at achieving a perforated film (microperforated and/or macroperforated) that are primarily based on the application of heat by means of electric resistances, and laser or heat radiation.

The drawbacks of these currently existing processes are that they need on the one hand a large amount of energy to complete the stamping proper, with sophisticated systems for monitoring temperature, and, on the other hand, that they require equipment that is very sensitive to modifications of the productive capacity and the characteristics of the final product due to its great complexity.

Furthermore, cold perforation (devoid of heat transmission) of certain types of plastics, basically polyethylenes, which are in addition widely used in the packaging processes, has always posed technical difficulties, unresolved heretofore, that have resulted in the “biting” of the perforated film edges which reduced the resistance properties of the film and its stretching capacity, this additionally generating both an excessive wear and tear of the working implements and tools resulting in high manufacturing costs and also a problem hard to solve such as the cleaning or elimination of the stamping residues in an effective way and their transport to the recycling system.

It is thus intended to achieve, through a process made as simplified as possible, a sheet made of macroperforated film basically used for securing palletized loads and for packaging goods requiring ventilation due to their particular characteristics, by means a cold stamping process that thus reduces energy consumption and achieves a highly controllable process that permits, in a single stamping process, obtaining one or several sheets of perforated film, having one or several layers, by adopting in the process an efficient system for the separation, collection and recovery of the perforated portion for subsequent recycling and reuse thereof.

### DETAILED DESCRIPTION OF THE INVENTION

The object of the machine for the manufacture of macroperforated plastic film by means of a cold-stamping process provided with an automated system for recovering the excess of material cut out for the recycling thereof is to produce a (single-layer or multi-layer) sheet of macroperforated film through a cold-stamping process. Both the size and the geometry as well as the arrangement of the holes can be modified depending on the applications desired for the final product. In order to achieve this goal it has been devised a system whereby after the roller (or rollers) have been fed with plastic film, it follows the feeding of film for further automatic unwinding in order to feed a double roller that rotates concurrently. One of these cylinders, the stamping cylinder, is provided on its surface with an array of reliefs featuring both the desired shape and arrangement. The entire stamping assembly is shaped in tempered steel. The film, while passing through both rollers, is submitted to such a pressure that the stamping cylinder attains complete and clean cuts of each one of the holes to be made. This pressure can be conveniently adjusted thanks to a system of hydraulic pressure manometers depending on the material to be stamped and the thickness thereof. Once the plastic sheet or sheets have been stamped, it is injected pressurized air through the lower portion by means of a perforated rod such that the cut out disc can be separated from the stamped sheet. This recovery system is perfected by a continuous suction system located right above the rod and above the plastic sheet such that the material residues (cut-out discs) can be suctioned and carried to a receiving tank for recycling thereof. The sheet is thus macroperforated and ready to be wound again on a roller located at the end of the line.

The assembly is perfected by a mechanical rollers device that permits to maintain the tension of plastic sheet constant while the stamping and the recovery processes are taking place. Furthermore, the machine has also been provided with a gear system that permits to easily proceed with the replacement of the stamping cylinder if required for the final product.

The whole process is carried out through verified systems so as to reduce the amount of static electricity that this type material naturally has.

The so designed system permits a multiplicity of entry exit (e-e) options that may consist of; an entry roller-an exit roller (1e-1e) whereby a macroperforated single-layer film is obtained; n entry rollers-n exit rollers (ne-ne), n being the number of rollers coupled at the entry and at the exit, thus it being obtained n rollers of macroperforated single-layer film; 2 n entry rollers-n exit exit rollers (2ne-ne), thus it being obtained n exit rollers of macroperforated multi-layer film. The combinations so obtained would be virtually unlimited in number.

### DESCRIPTION OF THE DRAWINGS

The present specification is accompanied by a series of drawings that describe the process and are intended to graphically illustrate the above-described manufacturing process.

FIG. 1 shows a side view of the machine assembly. Letters A and B refer to rotating cylinders into which the rollers with entry and exit material are inserted. In order to achieve an efficient rotation devoid of gliding, these cylinders are provided with a pneumatic adjustment system that actuates on the roller mandrels. Letter C stands for the tensioning system that allows the plastic sheet to pass through the stamping process with virtually constant tension. When several rollers are fed in A the perforated film passes through the set of rollers D in order to either become separated in single-layer sheets or form a single-layer sheet. The perforated sheet is then subjected to the recovery process of the stamped portion by means of the blowing performed through rod E and the excess material is suctioned by F and carried to the storing area for recycling thereof. In this same figure stamping cylinder G and control board H are illustrated.

FIG. 2 shows a simplified diagram of the unwinding process, the stamping, and the cleaning, recovery and winding system of the macroperforated material.

FIG. 3, like FIG. 2, shows the same diagram although it pinpoints the most significant parts of the process; the untreated plastic roller (1) is unwound and the film (2) passes through pinch rollers (3) and punching machine (4), the required pressure adjustment being performed on shaft (5). Perforated rod (6) placed underneath the stamped film lets the air pass, which air is introduced under pressure through the end (7) thereof, this resulting in the separation of the excess plastic portion that is then received in suction pipe (8) and carried through duct (9) to the collection area.

FIG. 4 shows the variant described for n entry rollers-n exit rollers (two entry rollers and two exit rollers are illustrated for the sake of clarity of the drawing). The separation of the sheets is carried out at the exit of the recovery process of the excess cut-out material such that the stamping process is simultaneous as regards both sheets.

FIG. 5 shows the variant described for 2n entry rollers-n exit rollers (combinations 2-1 and 4-2 are illustrated for the sake of simplicity of the drawing) such that it is obtained a multi-layer film (2) in this case.

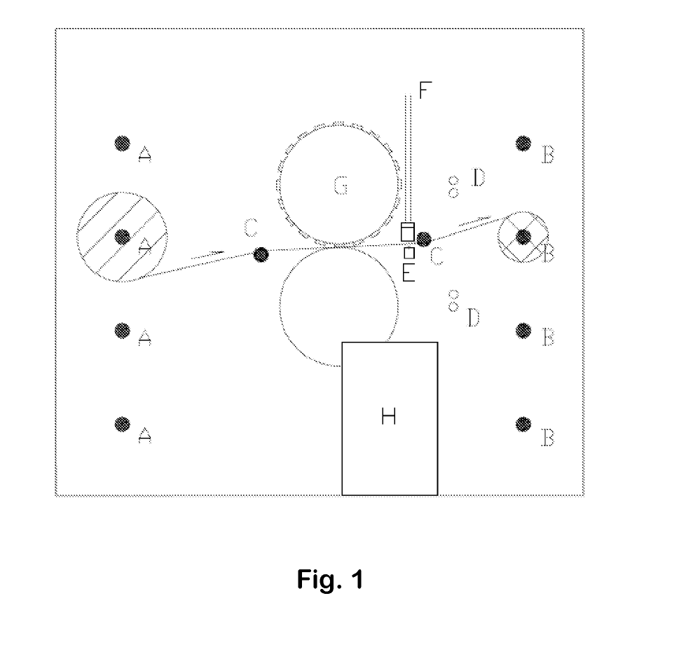

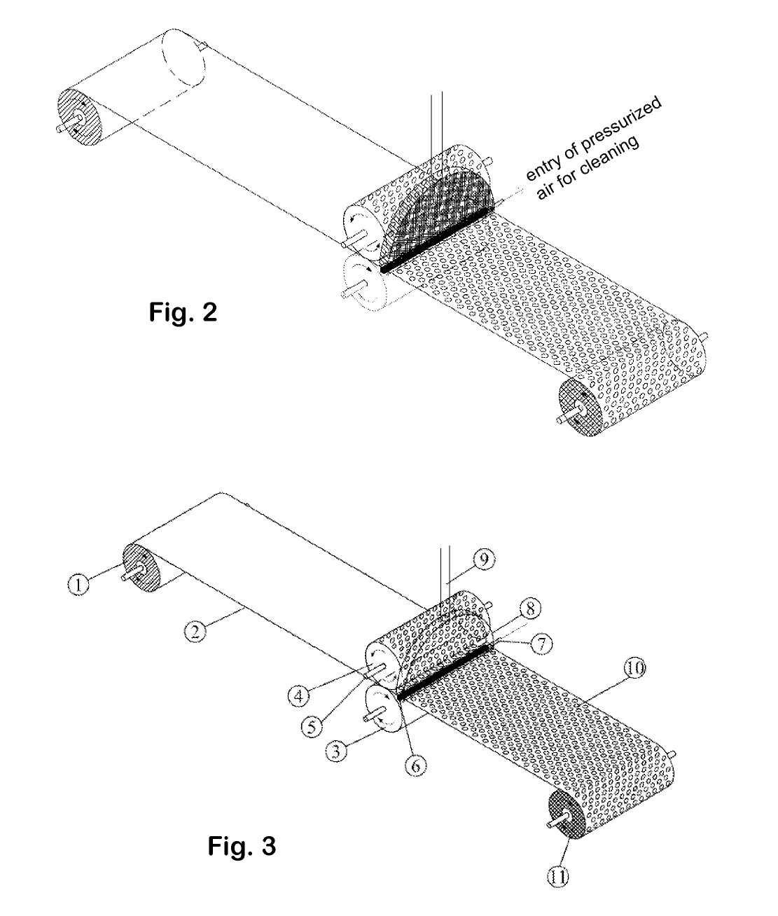

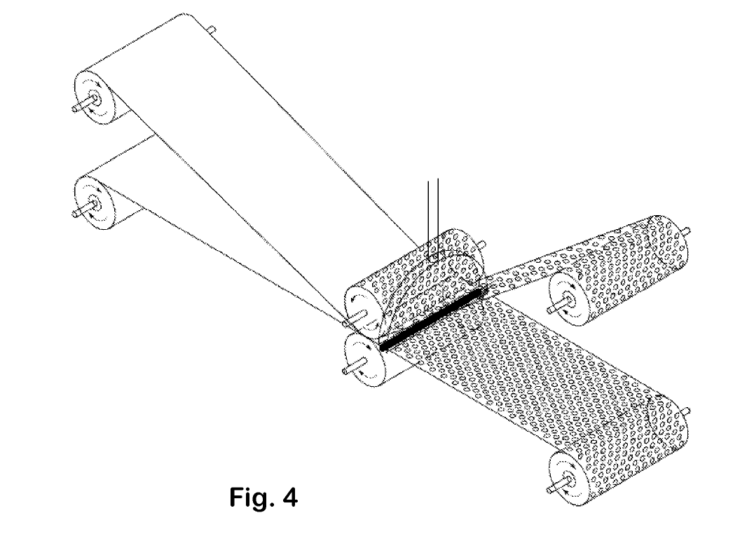

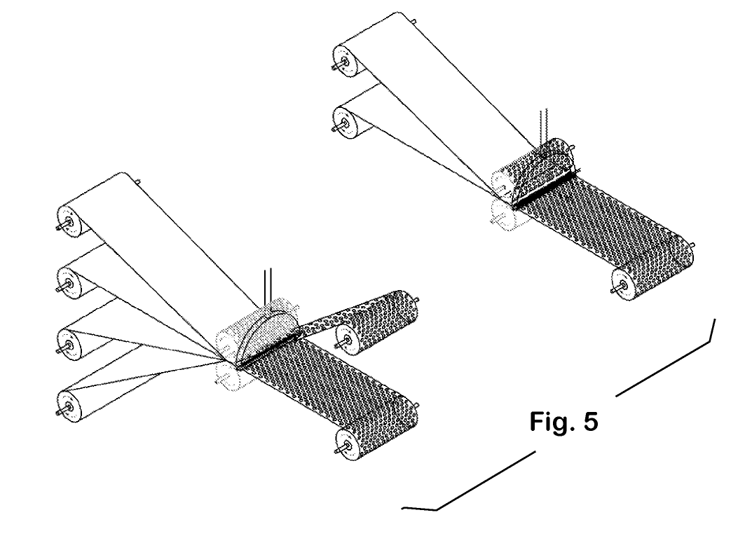

### FIG. 2

ENTRADA DE AIRE A PRESION PARA LIMPIEZA (es):

ENTRY OF PRESSURIZED AIR FOR CLEANING (en)

1-6. (canceled)

7. A macroperforator machine for plastic film, wherein the machine performs cold-stamping through controllable pressure.

8. A macroperforator machine according to claim 7, wherein the machine simultaneously performs macroperforations on one or several plastic sheets with different stamping geometric figures.

9. A macroperforator machine for plastic film according to claim 7, characterized by its modularity, compactness and low energy consumption.

10. A macroperforator machine for plastic film according to claim 7, further comprising an automatic system for cleaning and recovering excess material.

11. A macroperforator machine according to claim 7, further comprising a system for exchanging stamping rollers that permit manufacture of products featuring different finishes that are suitable for direct use or for use upon prior pre-stretching of the material.

12. A macroperforator machine for plastic film according to claim 7, further comprising a set of rollers that permit obtaining a single layer or multi-layer sheet depending on the requirements for the final product.
